(19) United States
(12) Patent Application Publication
(10) Pub. No.: US 2006/0016144 A1
(43) Pub. Date: Jan. 26, 2006

(54) Field assemblable panel door

(75) Inventor: Kenneth Jacobs, Guildford (GB)

Correspondence Address: PEPE & HAZARD, LLP, 225 ASYLUM ST., HARTFORD, CT, 06103, US

(73) Assignee: Home Decor Holding Company

(21) Appl. No.: 11/182,990

(22) Filed: Jul. 15, 2005

Related U.S. Application Data
(63) Continuation-in-part of application No. 10/724,191, filed on Dec. 1, 2003.
(63) Continuation-in-part of application No. 11/062,755, filed on Feb. 23, 2005.

(51) Int. Cl. E06B 3/70

(52) U.S. Cl. 52/455

(57) ABSTRACT

A field assemblable panel door comprises a pair of metallic stiles each having an outer wall, a pair of side walls extending perpendicularly thereto and an engagement element on the inner surface of the outer wall which provides a bore. The side walls provide a first inwardly opening panel receiving channel therebetween, and a pair of flanges on one side wall provide a second panel receiving channel. A pair of metallic rails each have inner and outer side walls, and a base wall extends between the inner ends of the side walls to provide an outwardly opening channel, and the base wall provides a second inwardly opening channel. Corner connectors join the ends of the stiles and rails to form a rectangular frame. The connectors have an outer end wall overlying the ends of the rails and a body portion extending in the outwardly opening channel. A fastener seated in the corner connector engages in the bore of the engagement element in the adjacent stile, and a panel is seated in the opposed inwardly opening channels of the stiles and in the inwardly opening channel of at least one of the rails.

### CROSS REFERENCE TO RELATED APPLICATIONS

The present application is a continuation-in-part of Applicant's earlier U.S. application Ser. No. 10/724,191, filed Dec. 1, 2003 and published on Jan. 6, 2005 as No. U.S. 2005/0000164, and of earlier U.S. application Ser. No. 11/062,755 filed Feb. 23, 2005.

### BACKGROUND OF THE INVENTION

The present invention relates to panel doors and, more particularly, to a panel door which may be assembled in the field from a small number of components, several of which may be cut to facilitate the fabrication of a door which will closely fit the space in which it is to be installed.

Panel doors are widely employed for closets and other interior locations and may utilize different materials for the panels. Sliding panel doors are mounted on and guided by top and bottom tracks, and it is frequently desirable to reduce the weight of such doors by using relatively thin panels including mirrors. Bypassing door and pocket door installations are frequent applications for such sliding doors.

Because the door openings in which the doors are to be installed may vary in dimension, it is sometimes necessary to order doors of non-standard dimensions to provide an attractive installation.

For many years, many panel doors have been assembled from rails and stiles which seat the panels therebetween. Most such doors have been factory assembled or fabricated by a millwork house to a specific size. Frequently this has required trimming of one or more edges for the installation.

To minimize such trimming on site and possible injury to the surface, a contractor may have to choose, order and inventory a variety of door sizes to avoid delay for custom measured doors.

It is an object of the present invention to provide a novel field assemblable panel door which requires only a few components which can be readily trimmed to the desired size on site.

It is also an object to provide such a door which can be fabricated relatively economically and for which the components may be readily stored in a small space.

Another object is to provide such a door in which the panels may be readily changed.

### SUMMARY OF THE INVENTION

It has now been found that the foregoing and related objects may be readily attained in a field assemblable panel door comprising a pair of metallic stiles each having an outer wall, a pair of side walls extending perpendicularly thereto, and an engagement element on the inner surface of the outer wall providing a bore. The side walls provide a first inwardly opening panel receiving channel therebetween, and a pair of flanges extend perpendicularly to the outer surface of one of the perpendicular walls provide a second inwardly opening panel receiving channel therebetween.

Coupled thereto are a pair of metallic rails each having an outer side wall, an inner side wall, and a base wall extending between the inner ends of the side walls. The base wall and side walls provide an outwardly opening panel receiving channel, and the base wall provides a third inwardly opening channel.

Corner connectors join the ends of the stiles and rails to form a rectangular frame. Each of the corner connectors has an outer end wall overlying the ends of the rails and a body portion extending in the outwardly opening channel in the rail. The connector has an upwardly opening recess adjacent the outer end wall, and a fastener seated in the recess has a shank engaged in the bore of the engagement element in the adjacent stile. A panel is seated in the opposing inwardly opening channels of the stiles and in the inwardly opening channel of at least one of the rails.

Preferably, the base wall of the top and bottom rails has an inverted U-shaped center portion and web portions joined to the inner ends of the side walls. The center portion provides a third inwardly opening channel, and the side walls of said rails having inturned lip portions on the outer ends thereof providing guide channels. Desirably, the stiles have a transverse wall extending between the perpendicular walls intermediate the ends thereof.

Preferably, a wall extends perpendicularly to the transverse wall parallel to the side walls to divide the first panel receiving channel. The engagement element may be of generally C-shaped cross section, and the fastener extends through an aperture in the center portion of the rail.

Generally, there is included an intermediate or tie rail extending between the stiles intermediate the height thereof and providing top and bottom channels seating one edge of each of a pair of panels. The intermediate rail has a side wall with a generally C-shaped cross section providing a channel in the outer surface thereof and intermediate rail connectors are seated at the ends of the channel in the tie rail and engaged in the stiles. A fastener seated in the intermediate rail connector bears upon the rail to bias the panel against the free end portions of the C-shaped side wall.

Usually, the panel receiving channels in at least some of the stiles and rails are of greater width than the thickness of the panels and there are included spacers which snugly fit in the channels to press the panels tightly against a side of the channel.

### BRIEF DESCRIPTION OF THE DRAWINGS

FIG. 1 is a perspective view of a field assembled panel door embodying the present invention;

FIG. 2 is a fragmentary top view of an upper corner of the door in FIG. 1 and drawn to an enlarged scale;

FIG. 3 is a cross sectional view of a stile in the door of FIG. 1 drawn to an enlarged scale;

FIG. 4 is a cross sectional view of a top or bottom rail drawn to an enlarged scale;

FIG. 5 is a cross sectional view of the tie or intermediate rail of FIG. 1 drawn to an enlarged scale;

FIG. 6 is a plan view of a rail connector;

FIG. 7 is a perspective view of the rail connector;

FIG. 8 is a bottom perspective view of the intermediate or tie rail connector;

FIG. 9 is a cross sectional view of the intermediate or tie rail connector;

FIG. 10 is an end elevational view of a spacer array;

FIG. 11 is a perspective view of the corner components with portions broken away;

FIG. 12 is a fragmentary cross sectional view of the assembled rail and corner connector;

FIG. 13 is a cross sectional view of the assembled stile, tie rail and connector and pivotal guide wheel; and

FIG. 14 is a fragmentary perspective view of an intermediate rail, connector, spacer and panels with a portion in section.

### DETAILED DESCRIPTION OF THE ILLUSTRATED EMBODIMENT

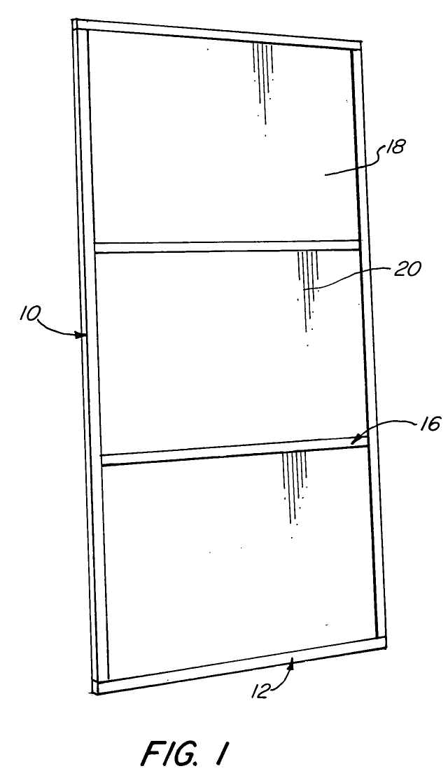

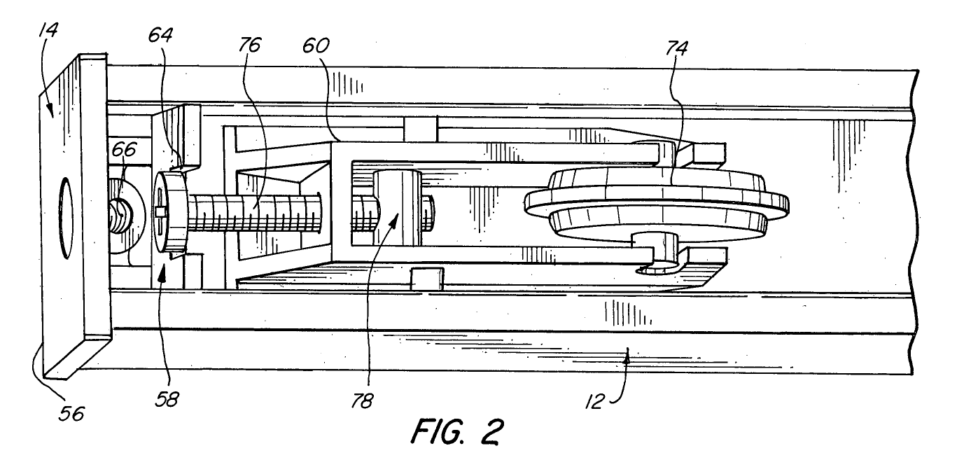

Turning first to FIGS. 1 and 2, therein illustrated is a field assemblable door embodying the present invention and comprised of a pair of stiles generally designated by the numeral 10, a pair of top and bottom rails extending therebetween and generally designated by the numeral 12, corner connectors generally designated by the numeral 14, an intermediate or tie rail generally designated by the numeral 16, and panels generally designated by the numerals 18 and 20.

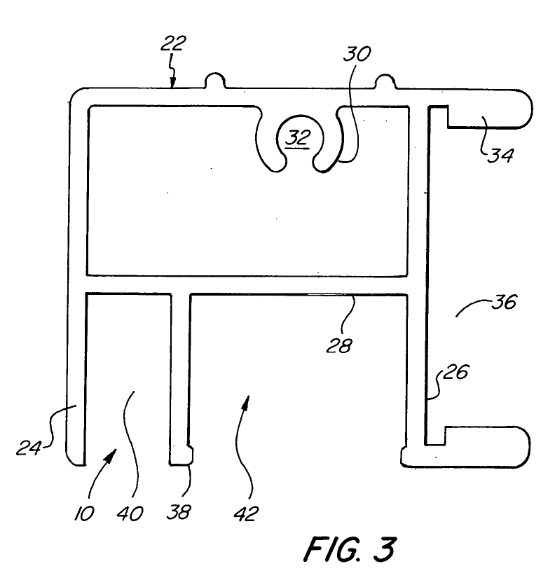

Turning next to FIG. 3, the stiles 10 have an outer wall 22, a pair of walls 24, 26 extending perpendicularly to the outer wall 22, and a wall 28 extending transversely between the perpendicular walls 24, 26 intermediate the ends thereof, and a generally C-shaped engagement element 30 on the inner surface of the outer wall 22 and providing a bore 32.

The perpendicular walls 24, 26 have inwardly disposed flanges or lips 34 at the free ends thereof and defining a first channel 36 therebetween and a divider wall 38 on the transverse wall 28 parallel to and spaced from the perpendicular walls 24, 26 to define second and third channels 40, 42.

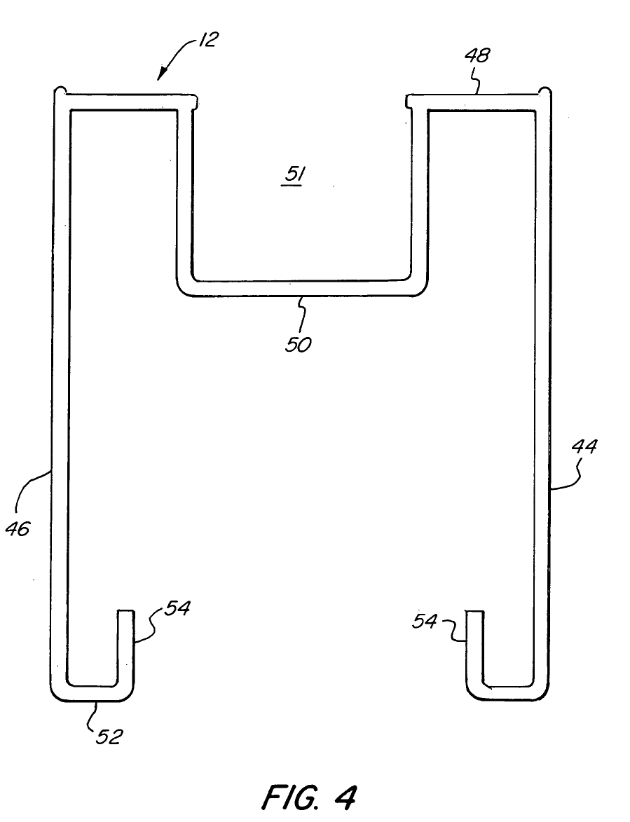

Turning now to FIG. 4, the top and bottom rails 12 have an outer side wall 44, and inner side wall 46, a base wall 48 with an inverted U-shaped center portion 50 providing a third panel receiving channel 51 and web portions 52 connected to the and side walls 44, 46 which have inturned lips 54 on their free ends.

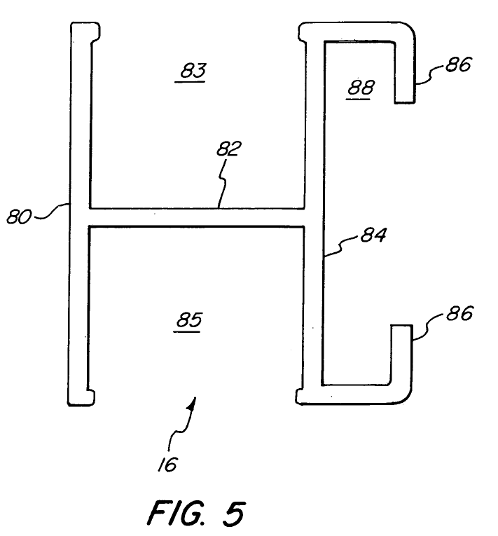

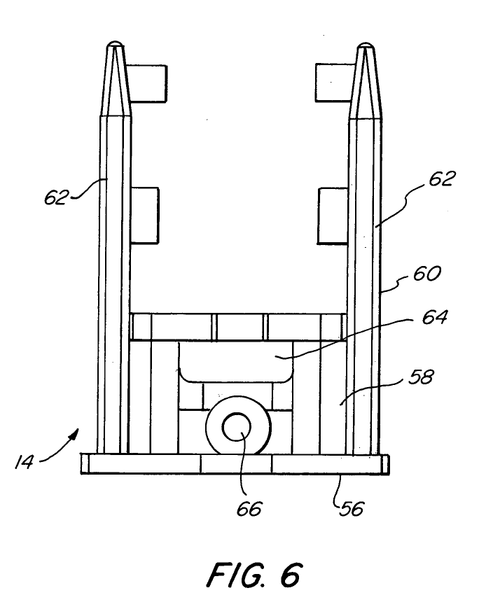

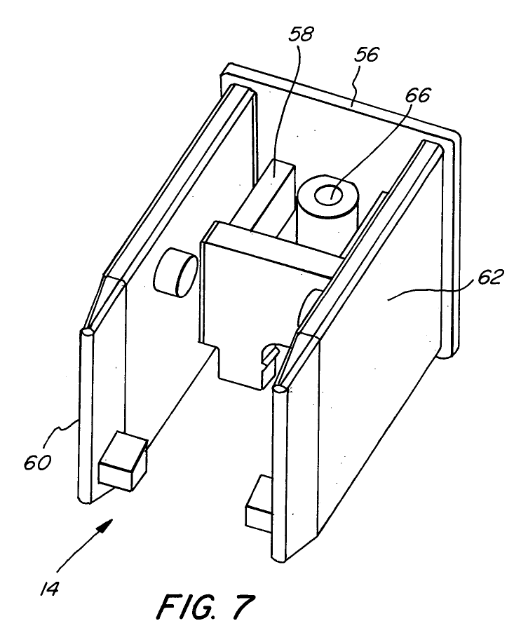

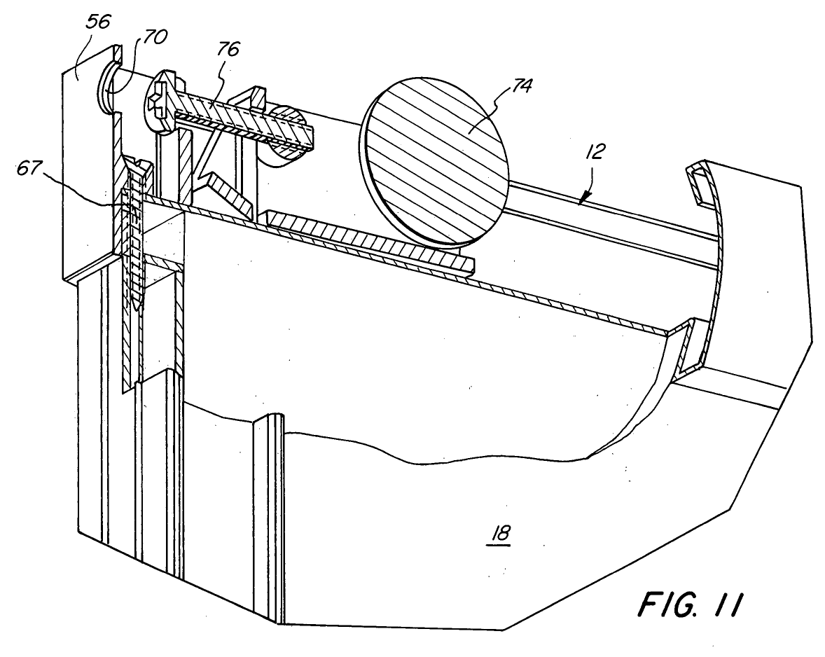

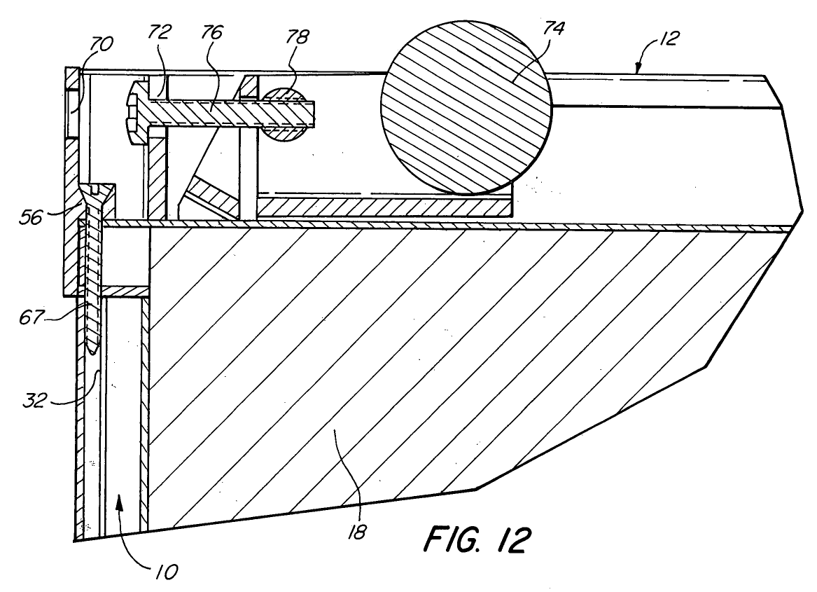

Turning next to FIGS. 5, 6 and 11-12, the corner connector 14 has an outer end wall 56, a body portion 58 and a projecting portion 60 including side elements 62 which seat in the channels provided by the lips 54 and in the channels provided between the U-shaped portion 50 and side walls 44, 46. The body portion 58 has a T or key-shaped recess 64 at its inner end and a second recess 66 at its outer end. An aperture 68 extends from the bottom of the recess 66 and a fastener 67 seated therein extends through the body portion 58 and the underlying wall of the U-shaped portion 50 of the rail 14 to bite into the bore 32 of the engagement element 30. An aperture 70 is provided in the outer end wall 56 and an aligned passage 72 is provided in the body portion 58.

As seen in FIG. 2, the corner connector 14 is coupled to a pivotable guide wheel assembly generally designated by the numeral 74 by a threaded fastener 76 having a head seated in the T-shaped recess 64 and a shank threadably engaged in the nut 78. The head of the fastener 74 may be engaged by a screw driver (not shown) inserted through the aperture 70 on the outer end wall 56.

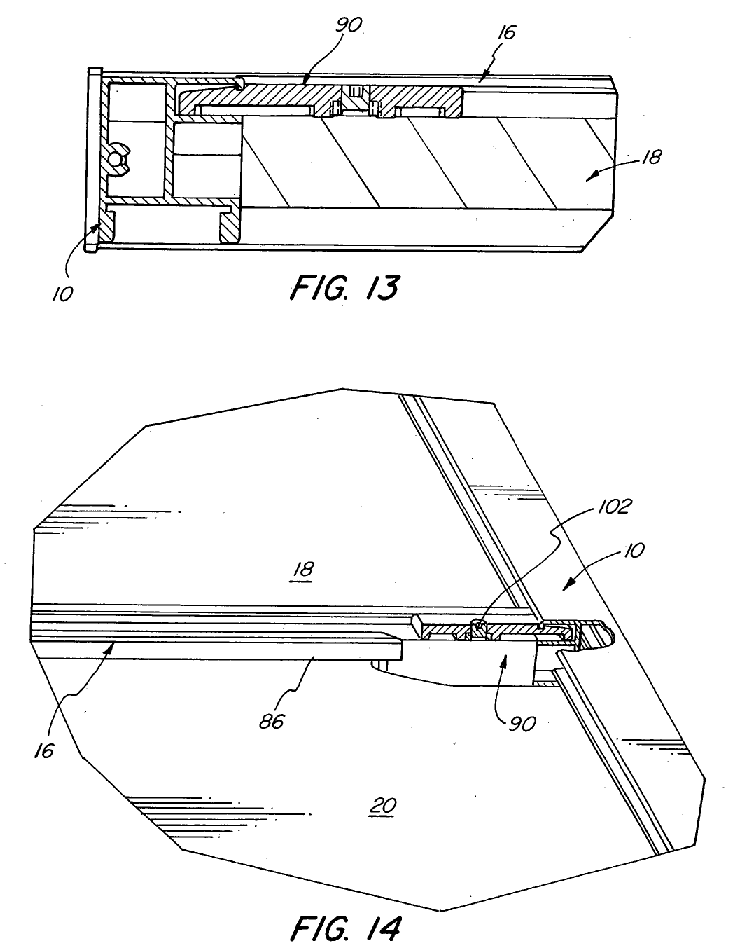

Turning next to the cross or tie rails 16 as seen in FIGS. 5, and 13-14, they are generally H-shaped in cross section with an outer wall 80, a perpendicularly extending web 82, and a C-shaped inner wall 84 having inwardly extending lip portions 86 providing opposed channels 88. The walls 80, 84 and web 82 define upper and lower panel receiving channels 83, 85.

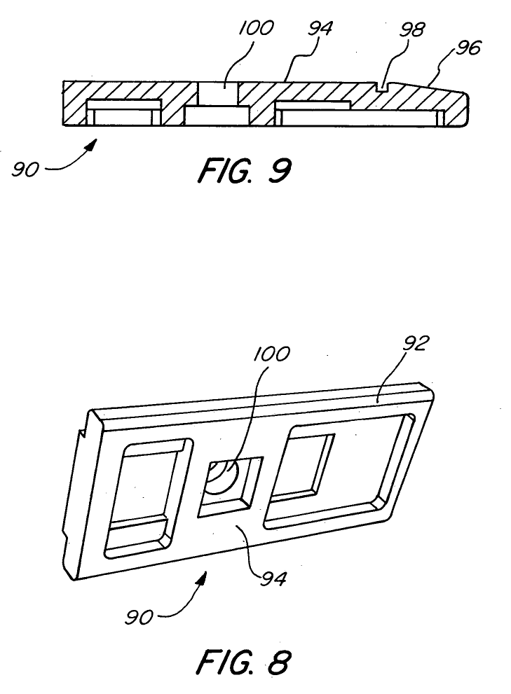

As seen in FIGS. 8 and 9, the tie rail connectors generally designated by the numeral 90 are of generally rectangular cross section slidably seat in the channel provided by the inner wall 84 and lips 86. These connectors 90 have steps 92 in their outer face extending along both longitudinally edges thereof so that the center section 94 lies in substantially the same plane as the lip portions 86 and the face of the stile 10.

The outer face at the stile end of the tie rail connector 90 has a sloping surface 96 terminating at a transverse recess 98.

An aperture 100 is provided centrally of the connector in which are seated a set screw and nut 102 which bear against the tie rail, thus pressing the connector outwardly against the lip portions 86.

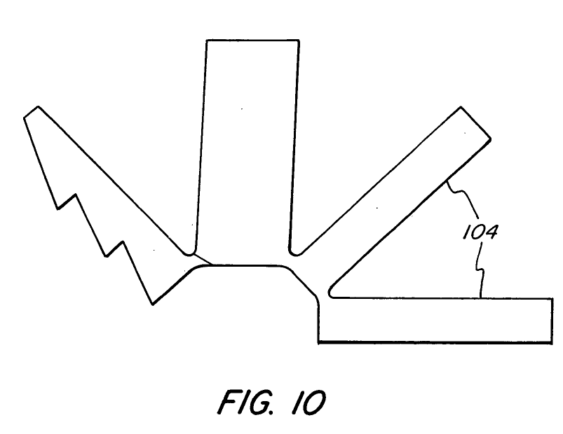

To securely seat the panels 18, 20 in the channels, resilient spacers 104 are provided in several thicknesses. The appropriate spacers 104 is pressed into the channels of the several rails and stiles. FIG. 10 illustrates an extruded spacer array 106 from which the appropriately dimensioned spacer may be cut.

In assembling a panel door from the previously described components, the desired dimensions are first determined and the stiles and/or rails are cut to the desired length. The panels may also be trimmed if necessary.

A pair of stiles 10, and a top and bottom rail 12 are then assembled by inserting corner connectors 14 into each end of the outwardly opening rail channel, and inserting and engaging threaded fasteners in the bore 32 of the stiles 10.

A first panel 18 is then slid into the other end of the stiles 10 and slid in the opposing channels 36 of the stiles 10 until it seats in the channel provided by the U-shaped portion of the rail 12.

An intermediate or tie rail 16 is now placed between the stiles 10 and moved to seat the edge portion of the panel 20 in the channel 83. The connectors 90 which have been inserted into the channels 88 are then moved against the stiles 10 with a lip on the stile walls seating in the recess 98 of the connector.

A second panel 20 may now be slid into place to seat its edge portion in the other channel 85 of the tie rail 16. If so desired, a second tie rail 16 may be similarly installed and a third panel 18, 20 may be mounted therewith.

The lower rail 12 is coupled to the stiles 10 in the seam manner and seats the edge portion on the last installed panel.

To secure the panels 18, 20 tightly with the rails 12, 16, resilient spacers 104 are inserted into the rail channels. The extruded array seen in FIG. 10 provides several different thicknesses to ensure a tight fit. The tie rail connector fasteners (not shown) are rotated to securely position the connectors 90 and thereby the rails 16.

As will be appreciated, the stiles 10 provide channels 40, 42 of different width to accommodate panels of different thicknesses.

The door may employ a self aligning guide roller or wheel assembly engaged with the corner connector is illustrated and described in application Ser. No. 11/062,755 filed Feb. 23, 2005.

Although the stiles and rails in the drawings are illustrated as metal extrusions, they may be roll formed from metal sheet. The corner and intermediate connectors are conveniently injection molded from synthetic resin. The spacers are also molded from synthetic resin.

With the present invention, there is no predrilling of the rails and stiles. The assembly screw will penetrate the rail wall and bite into the engagement element.

Commercial structures embodying the present invention accommodate panels from 3 to 12 mm, and panels of different thickness can be included in the same door. To lock the components, only a single screw at each corner and a hex key at each end of the tie rails are required. The door panels may be easily replaced.

Thus, it can be seen from the foregoing detailed specification and attached drawings that the field assemblable door of the present invention requires only a few components which can be readily trimmed on the site to fit the opening in which it will be mounted. The components are easily and economically fabricated, and the disassembled components can be stored in a small space to reduce maintaining a large number of factory assembled doors.

Having thus described the invention, what is claimed is:

1. A field assemblable panel door comprising:
(a) a pair of metallic stiles each having an outer wall, a pair of side walls extending perpendicularly thereto and an engagement element on the inner surface of said outer wall providing a bore, said side walls providing a first inwardly opening panel receiving channel therebetween, and a pair of flanges extending perpendicularly to the outer surface of one of said perpendicular walls providing a second inwardly opening channel therebetween;
(b) a pair of metallic rails each having an outer side wall, an inner side wall, and a base wall extending between the inner ends of said side walls, said base wall and side walls providing on outwardly opening panel receiving channel, said base wall providing a third inwardly opening channel;
(c) corner connectors joining the ends of said stiles and rails to form a rectangular frame, each of said corner connectors having an outer end wall overlying the ends of said rails and a body portion extending in said outwardly opening channel in said rail and having an upwardly opening recess adjacent said outer end wall;
(d) a fastener seated in said recess and having a shank engaged in said bore of said engagement element in the adjacent stile; and
(e) a panel seated in the opposing inwardly opening channels of said stiles and in said inwardly opening channel of at least one of said rails.

2. The field assemblable panel door in accordance with claim 1 wherein the base wall of said top and bottom rails has an inverted U-shaped center portion and web portions joined to the inner ends of said side walls, said center portion providing said third inwardly opening channel, said side walls having inturned lip portions on the outer ends thereof providing channels.

3. The field assemblable panel door in accordance with claim 1 wherein said stiles have a transverse wall extending between said perpendicular walls intermediate the ends thereof.

4. The field assemblable panel door in accordance with claim 3 wherein a wall extends perpendicularly from said transverse wall parallel to said side walls to divide the first panel receiving channel formed between said side walls.

5. The field assemblable panel door in accordance with claim 1 wherein said engagement element is of generally C-shaped cross section.

6. The field assemblable panel door in accordance with claim 5 wherein said fastener extends through said center portion of said rail.

7. The field assemblable panel door in accordance with claim 1 wherein there is included an intermediate rail extending between said stiles intermediate the height thereof and providing top and bottom channels each seating one edge of each pair of panels.

8. The field assemblable panel door in accordance with claim 7 wherein said intermediate rail has a side wall with a generally C-shaped cross section providing a channel in the outer surface thereof and intermediate rail connectors are seated at the ends of said channel in said rail and engage in said stiles.

9. The field assemblable panel door in accordance with claim 8 wherein a fastener is seated in said intermediate rail connector and bears upon said rail to bias the panel against the free end portions of said C-shaped side wall.

10. The field assemblable panel door in accordance with claim 1 wherein there the panel receiving channels in at least some of said stiles and rails are of greater width than the thickness of said panels and there are included spacers which snugly fit in said channels to press said panels tightly against a side of the channel.

11. A field assemblable panel door comprising:
(a) a pair of metallic stiles each having an outer wall, a pair of side walls extending perpendicularly thereto and an engagement element of C-shaped cross section on the inner surface of said outer wall providing a bore, said side walls providing a first inwardly opening panel receiving channel therebetween, said stiles having a transverse wall extending between said perpendicular walls intermediate the ends thereof and a pair of flanges extending perpendicularly to the outer surface of one of said perpendicular walls to provide a second inwardly opening panel receiving channel therebetween;
(b) a pair of metallic rails each having an outer side wall, an inner side wall, and a base wall extending between the inner ends of said side walls, said base wall and side walls providing an outwardly opening panel receiving channel, said base wall having an inverted U-shaped center portion providing a third inwardly opening panel receiving channel, web portions joining said center portion to the inner ends of said side walls, said side walls and said center portion providing an inwardly opening channels;
(c) corner connectors joining the ends of said stiles and rails to form a rectangular frame, each of said corner connectors having an outer end wall overlying the ends of said rails and a body portion extending inwardly of said outwardly opening channel in said rail and having an upwardly opening recess adjacent said outer end wall and;
(d) a fastener seated in said recess and having a shank extending through said center portion of said rail engaged in said bore of said engagement element in the adjacent stile; and
(e) a panel seated in the opposing inwardly opening channels of said stiles and in said inwardly opening channel of at least one of said rails.

12. The field assemblable panel door in accordance with claim 11 wherein a wall extends perpendicularly from said transverse wall parallel to said side walls to divide the first panel receiving channel formed between said side walls.

13. The field assemblable panel door in accordance with claim 11 wherein there is included an intermediate rail extending between said stiles intermediate the height thereof and providing top and bottom channels seating one edge of each pair of panels.

14. The field assemblable panel door in accordance with claim 13 wherein said intermediate rail has a side wall with a generally C-shaped cross section providing a channel in the outer surface thereof and intermediate rail connectors are seated at the ends of said channel in said rail and engage in said stiles.

15. The field assemblable panel door in accordance with claim 13 wherein a fastener is seated in said intermediate rail connector and bears upon said rail to bias the panel against the free end portions of said C-shaped side wall.

16. The field assemblable panel door in accordance with claim 13 wherein there the panel receiving channels in at least some of said stiles and rails are of greater width than the thickness of said panels and there are included spacers which snugly fit in said channels to press said panels tightly against a side of the channel.
